(19) United States
(12) Patent Application Publication
(10) Pub. No.: US 2015/0288233 A1
(43) Pub. Date: Oct. 8, 2015

(54) ROTOR AND MOTOR USING THE SAME

(71) Applicant: Samsung Electronics Co., Ltd., Suwon-si (KR)

(72) Inventors: Won Ho Kim, Hwaseong-si (KR); Seong Taek Lim, Suwon-si (KR); Jin Woo Cho, Seongnam-si (KR); Sung Il Kim, Yongin-si (KR)

(73) Assignee: Samsung Electronics Co., Ltd., Suwon-si (KR)

(21) Appl. No.: 14/675,931

(22) Filed: Apr. 1, 2015

(30) Foreign Application Priority Data
Apr. 2, 2014 (KR) 10-2014-0039285
Dec. 22, 2014 (KR) 10-2014-0186053

(51) Int. Cl. H02K 1/28; H02K 1/27

(52) U.S. Cl. CPC H02K 1/28; H02K 1/27

(57) ABSTRACT

A rotor and a motor using the same may include a cylindrical main core having an inner diameter and an outer diameter; a plurality of radial cores, each of which extends in a direction perpendicular to an outer circumference edge of the main core; a plurality of magnetic flux concentration cores placed between the radial cores, respectively; a plurality of inner coupling parts, each of which connects the main core and the plurality of magnetic flux concentration cores and has a width smaller than the width of the radial core; a rotor core having permanent magnet seating parts provided at both sides of the radial core in parallel with the radial core; and a plurality of permanent magnets placed on the permanent magnet seating parts, and magnetized such that opposite poles face each other with the radial core centered therebetween.

### CROSS-REFERENCE TO RELATED APPLICATIONS

This application claims the priority benefit of Korean Patent Application No. 10-2014-0039258 filed on Apr. 2, 2014, and Korean Patent Application No. 10-2014-0186053, filed on Dec. 22, 2014, in the Korean Intellectual Property Office, the disclosures of which are incorporated herein by reference.

### BACKGROUND

1. Field

The following description relates to a rotor capable of obtaining high output and preventing scattering, and a motor using the same.

2. Description of the Related Art

Motors are devices capable of obtaining a rotational force from electrical energy, and may include a stator and a rotor. The rotor is configured to interact with the stator and may be rotated by a force acting between a magnetic field and a current flowing through a coil.

In permanent magnets used for a rotor in a permanent magnet (PM) motor, rare earth (for example, neodymium (ND)) magnets having a high energy density and an excellent structural strength are susceptible to price fluctuation, and are expensive because mineral territories and mining sites are concentrated in specific territories. Thus, compared with a motor including a ferrite permanent magnet, the motor including the rare earth permanent magnet has a disadvantage in that a unit cost of the product is rising.

In recent years, therefore, a search for an alternative material that could replace the rare earth magnet has been conducted and research on a motor which employs the ferrite magnet through a structural modification which can obtain an output similar to that obtained from a motor using the rare earth magnet is in progress.

In addition, the rotor has a disadvantage in that internal elements of the rotor are scattered due to a centrifugal force while the rotor is rotated. Research for solving the above problems and obtaining mechanical reliability has been under way.

### SUMMARY

Additional aspects and/or advantages will be set forth in part in the description which follows and, in part, will be apparent from the description, or may be learned by practice of the disclosure.

Therefore, the following description relates to a rotor which can obtain a high output when rotated at high and low speeds and prevent scattering when rotated at a high speed to provide mechanical reliability, and a motor using the same.

A rotor may include a cylindrical main core having an inner diameter and an outer diameter which have diameters different from each other; a plurality of radial cores, each of which has a width W2 and extends in a direction perpendicular to an outer circumference edge of the main core; a plurality of magnetic flux concentration cores placed between the plurality of radial cores, respectively; a plurality of inner coupling parts, each of which connects the main core and the plurality of magnetic flux concentration cores and has a width W1 smaller than the width W2 of the radial core; a rotor core having permanent magnet seating parts provided at both sides of the radial core in parallel with the radial core; and a plurality of permanent magnets placed on the permanent magnet seating parts, and magnetized such that opposite poles face each other with the radial core centered therebetween.

The rotor core may further include a plurality of inner magnetic flux leakage preventing parts provided at both sides of each of a plurality of inner coupling parts, and the plurality of inner magnetic flux leakage preventing parts may include a nonmagnetic material.

The rotor core may further include a plurality of outer coupling parts which connects the plurality of radial cores and the plurality of magnetic flux concentration cores and each of which has a width W4 smaller than a width W2 of the radial core, and the rotor core may further include a plurality of outer magnetic flux leakage preventing parts placed between the plurality of outer coupling parts and the plurality of permanent magnets, respectively. Also, the plurality of outer magnetic flux leakage preventing parts may include a nonmagnetic material.

A motor may include a shaft; a stator including a plurality of coils placed at a plurality of teeth, respectively; and a rotor including a cylindrical main core having an inner diameter and an outer diameter which have diameters different from each other; a plurality of radial cores, each of which has a width W2 and extends in a direction perpendicular to an outer circumference edge of the main core; a plurality of magnetic flux concentration cores placed between the plurality of radial cores, respectively; a plurality of inner coupling parts, each of which connects the main core and the plurality of magnetic flux concentration cores and has a width W1 smaller than the width W2 of the radial core; a rotor core having permanent magnet seating parts provided at both sides of the radial core in parallel with the radial core; and a plurality of permanent magnets placed on the permanent magnet seating parts, and magnetized such that opposite poles face each other with the radial core centered therebetween.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is an axial sectional view of a motor according to an embodiment of the present disclosure;

FIG. 2 is a cross-sectional view of a motor according to an embodiment of the present disclosure;

FIG. 3 is a cross-sectional view of a rotor according to an embodiment of the present disclosure;

FIG. 4 is a cross-sectional view of a rotor core according to an embodiment of the present disclosure;

FIG. 5 is a perspective view of a rotor according to an embodiment of the present disclosure;

FIG. 6 is a view showing a concept of a magnetization direction of a plurality of permanent magnets magnetized to a rotor according to an embodiment of the present disclosure;

FIG. 7 is a view showing a concept that a magnetic flux of a plurality of permanent magnets according to an embodiment of the present disclosure is concentrated into a magnetic flux concentration core;

FIG. 8 is a view showing a concept that a q-axis inductance is increased by a radial core according to an embodiment of the present disclosure;

FIG. 9 is a view showing displacement caused by a centrifugal force of a rotor in a simulation according to an embodiment of the present disclosure;

FIG. 10 is a view showing a stress caused by a centrifugal force of a rotor in a simulation according to an embodiment of the present disclosure;

FIG. 11 is a cross-sectional view of a motor according to an embodiment of the present disclosure;

FIG. 12 is a cross-sectional view of a rotor according to an embodiment of the present disclosure;

FIG. 13 is a cross-sectional view of a rotor core according to an embodiment of the present disclosure;

FIG. 14 is a graph showing a process for determining an operating point of a motor through a permeance coefficient;

FIG. 15A is a view showing a concept of magnetization directions of a plurality of permanent magnets magnetized to a rotor according to an embodiment of the present disclosure;

FIG. 15B is a perspective view of a permanent magnet including a planar chamfering part according to an embodiment of the present disclosure;

FIG. 16A is a view showing a concept of magnetization directions of a plurality of permanent magnets magnetized to a rotor according to an embodiment of the present disclosure; and

FIG. 16B is a perspective view of a permanent magnet including a rounded chamfering part according to an embodiment of the present disclosure.

### DETAILED DESCRIPTION

Reference will now be made in detail to the embodiments of the present disclosure with reference to the accompanying drawings so that one skilled in the art can easily understand and reproduce the present disclosure. In the description of the present disclosure, however, if it is judged that the known functions or structures can unnecessarily obscure the embodiments, a concrete description thereon will be omitted.

The terminologies used herein are selected in light of functions in the embodiments, the meaning thereof may be changed according to an intention of a user or operator or a practice. Therefore, the meaning of terminologies used the embodiment described below follow the definitions if the terminologies are concretely defined, and should be interpreted as the meaning which is ordinarily recognized by one skilled in the art if the terminologies are concretely defined.

In addition, it should be understood that the shapes or the structures of the embodiments, which are selectively described herein, may be freely combined with each other unless instructed otherwise even though the shapes or the structures are shown as single combined structure in the drawings.

Hereinafter, the embodiment of a rotor and a motor using the same will be described with reference to the accompanying drawings.

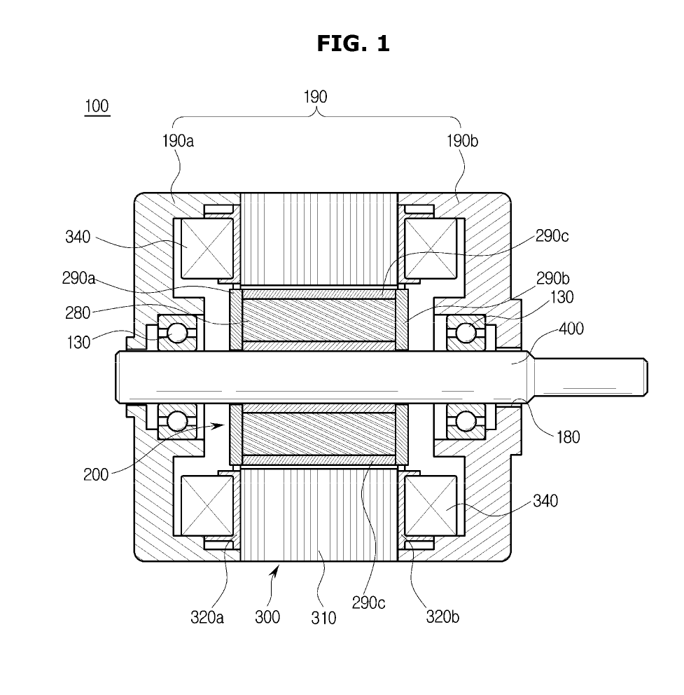

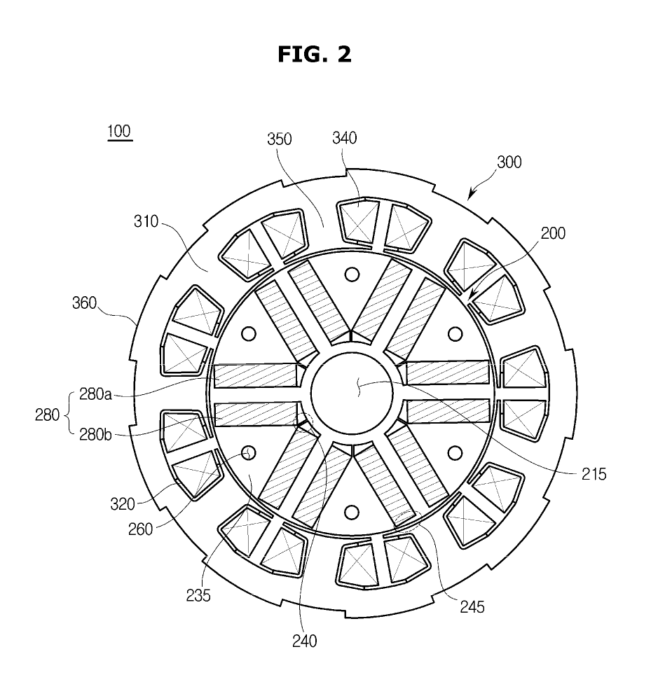

Hereinafter, the embodiment of a motor including a rotor will be described with reference to FIG. 1 and FIG. 2.

FIG. 1 shows an axial section of the motor and FIG. 2 shows a cross-section of the motor.

A motor 100 may include a motor housing 190, a stator 300, a shaft 400, and a rotor 200.

The motor housing 190 forms an exterior of the motor 100 and is coupled to a fixing protrusion 360 of the stator 300 to provide a fixing force to prevent the stator 300 from being rotated.

In addition, the motor housing 190 may be divided into a first motor housing 190a and a second motor housing 190b based on a horizontal axis. And, the first motor housing 190a and the second motor housing 190b may be connected to the stator 300.

The stator 300 may include a stator core 310, teeth 350, a coil 340, an insulator 320, and the fixing protrusion 360.

The stator core 310 forms a framework of the stator 300 to maintain a shape of the stator 300 and may provide a passage in which a magnetic field is formed such that, when one tooth 350 is magnetized by power, another tooth 350 which is adjacent to the one tooth 350 can be inductively magnetized to have a polarity opposite to that of the tooth magnetized by the power.

In addition, the stator core 310 may be formed to have a cylindrical shape and may be formed by stacking metal sheets machined by pressing. Furthermore, the plurality of teeth 350 may be placed on an inner circumference surface of the stator core 310 in the circumferential direction and the plurality of fixing protrusions 360 may be placed on an outer circumference surface of the stator core 310. In addition to that, various shapes for enabling the shape of the stator 300 to be maintained and for enabling the teeth 350 and the fixing protrusion 360 to be placed may be used as an example of the shape of the stator core 310.

Also, a plurality of first inserting holes passing through the stator core 310 in the axial direction may be formed on the stator core 310. In addition, a fastening member such as a pin, a rivet, or a bolt for coupling plates constituting the stator core 310 may be inserted into each of the first inserting holes.

A first inserting protrusion which is coupled to the first inserting hole of the stator core 310 in a male-female connection is formed on each of the first motor housing 190a and the second motor housing 190b so that the first motor housing 190a may be connected to the stator 300 and the second motor housing 190b may be connected to the stator 300. And, housing through holes corresponding to the first inserting hole of the stator core 310 are formed on the first motor housing 190a and the second motor housing 190b, respectively, so that the first motor housing 190a, the second motor housing 190b, and the stator 300 may be connected by one fastening member.

The plurality of teeth 350 may be placed in the stator core 310 to divide an internal space of the stator core 310 into a plurality of slots in the circumferential direction. Also, the tooth 350 may provide a space in which the coil 340 is placed, and the teeth may be magnetized to have one of an N pole and an S pole by the magnetic field formed due to power supplied to the coil 340.

In addition, each of the teeth 350 may have a Y shape, and one of peripheral faces of the tooth 350, which is adjacent to the rotor 200, may have a curved face to effectively generate an attractive force and a repulsive force between the tooth and a magnetic flux concentration core 235 in the rotor 200. In addition to that, various structures for providing a space in which the coil 340 is placed and for effectively generating the attractive force and the repulsive force between the tooth and the magnetic flux concentration core 235 may be employed as an example of the teeth 350.

The coil 340 may be placed on the insulator 320 placed on the tooth 350 of the stator 300 to generate the magnetic field due to the power applied thereto. Thus, the coil 340 can magnetize the tooth 350 on which this coil 340 is placed.

The power supplied to the coil 340 may be three phase or may have a single phase.

For example, in the case in which the power supplied to the coil 340 is a three phase type, three pairs of the coils 340 are grouped and U-phase power is supplied thereto, another three pairs of the coils 340 are grouped and V-phase power is supplied thereto, and the remaining three pairs of the coils 340 are grouped and W-phase power may be supplied thereto.

In addition to that, a variety of combinations of the coils 340 for controlling a rotation of the rotor 200 and effectively creating the attractive force and the repulsive force between the magnetic fields of the rotor 200 and stator 300 may be employed as an example of the combination of the coils 340.

In addition, the coil 340 may be wound by a concentrated winding method and a distributed winding method. The concentrated winding method is a method in which the coil 340 is wound to form one slot having one pole and one phase in the stator 300, and the distributed winding method refers to a method in which the coil 340 is wound around two or more slots in electric equipment to which the slots are attached. Various methods for effectively magnetizing the teeth 350 may be used as an example of the method for winding the coil 340.

Finally, a material used for the coil 340 may be copper, aluminum, or a composite material of copper and aluminum. In addition to that, various materials for effectively magnetizing the teeth 350 may be employed as an example of the material of the coil 340.

The insulator 320 is an insulating member for preventing the stator 300 formed of a material having electromagnetic conductivity from being in contact with and being electrically connected to the coil 340, and the insulator 320 may be divided into a first insulator 320a and a second insulator 320b.

The first insulator 320a and the second insulator 320b are formed of a material having electric insulation and are disposed at both sides of the stator core 310 with respect to the axial direction. The first insulator 320a and the second insulator 320b are coupled to both sides of the stator core 310, respectively, to cover the stator 300.

In addition, a second inserting protrusion is formed on each of the first insulator 320a and the second insulator 320b and protrudes toward the stator core 310, and the second inserting protrusion can be inserted into a second inserting hole formed in the stator core 310.

Each of the first insulator 320a and the second insulator 320b may include an annular edge, a plurality of coil supporting parts arranged to correspond to the stator core 310, and a coil guide part protruding from an inner side and an outer side of the coil supporting part in the radial direction.

In addition, the coil supporting parts may be spaced from each other in the circumferential direction to enable a space corresponding to the slot of the stator 300 to be formed between the coil supporting parts.

The fixing protrusion 360 may provide the fixing force for fixing the stator, as the stator 300 is not rotated in the second housing, but is fixed even though the rotational force is generated due to the attractive force and the repulsive force between the magnetic field formed by applying the power to the coil 340 and the magnetic field formed by the permanent magnet 280.

In addition, the fixing protrusion 360 may be formed on an outer barrier wall of the stator core 310 perpendicular to or parallel to the shaft 400 to enable the fixing protrusion to be coupled to a recess of the motor housing 190 in a male-female connection. In addition to that, the various fixing shapes for fixing the stator 300 to the motor housing 190 may be employed as an example of the fixing protrusion 360.

In order to enable the shaft 400 to be rotated together with the rotor 200, the shaft may be connected to a shaft inserting hole 215 of the rotor 200. One side of the shaft 400 is rotatably supported on the second motor housing 190b through a bearing 130, and the other side of the shaft 400 is rotatably supported on the first motor housing 190a through the bearing 130. In addition, one side of the shaft 400, which is supported on the second motor housing 190b, protrudes to an outside of the motor housing 190 through an opening 180 formed in the second motor housing 190b and may be then connected to a device requiring a driving force.

The rotor 200 is a device in which an attractive force and a repulsive force are formed between the magnetic field caused by the permanent magnet 280 and the magnetic field formed on the teeth 350 of the stator 300 to obtain the rotational force of the motor 100. The rotor 200 is placed in the stator 300, and a first rotor housing 290a and a second rotor housing 290b may be provided on radial faces of the rotor 200 and a third rotor housing 290c may be provided on an axial face of the rotor 200. The rotor 200 may include a rotor core 210 and the permanent magnet 280.

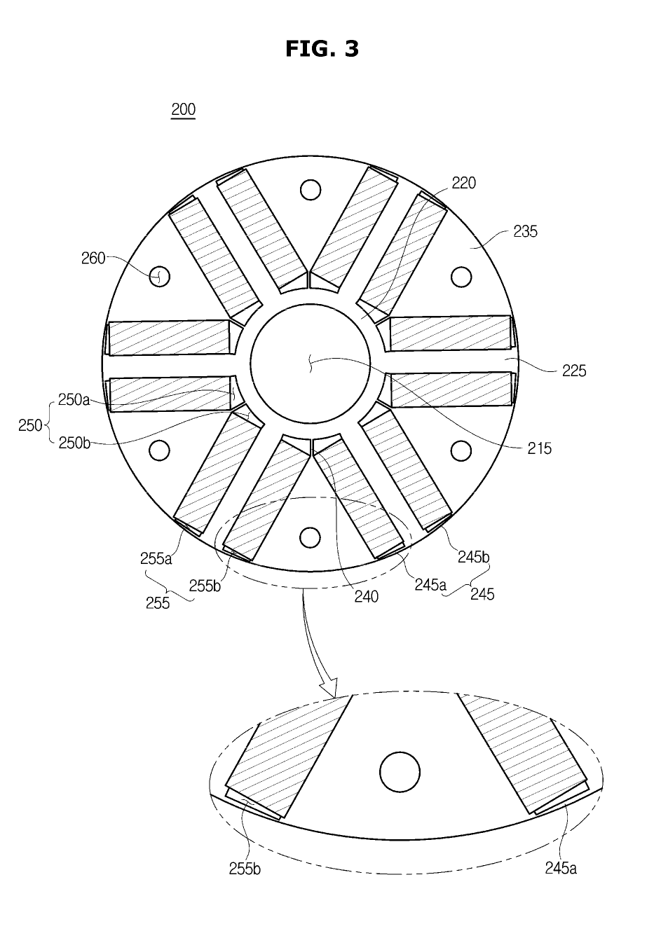

The rotor 200 will be described below in detail with reference to FIG. 3 to FIG. 5.

Hereinafter, an embodiment of the rotor will be described with reference to FIG. 3 to FIG. 5.

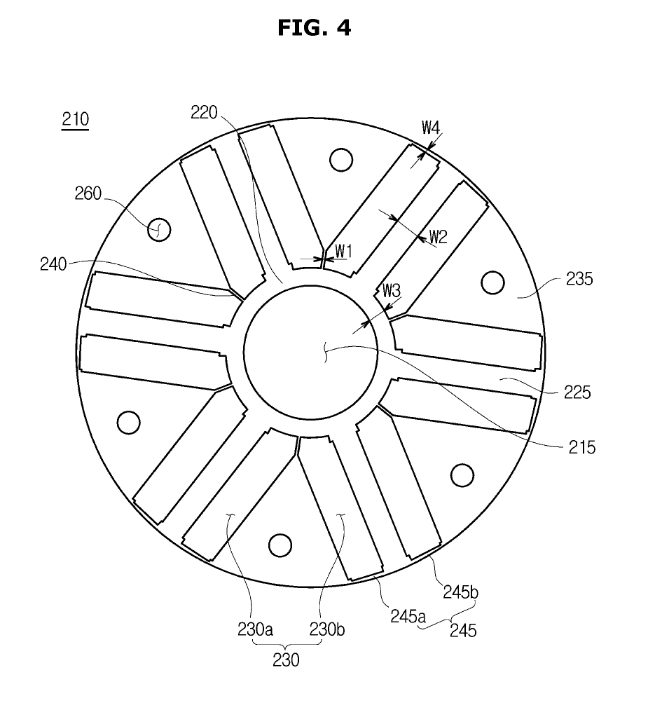

FIG. 3 shows a cross-section of the rotor and FIG. 4 shows a cross-section of the rotor core.

The rotor 200 may include the rotor core 210 acting as a passage of the magnetic field formed by the permanent magnet 280, concentrating a magnetic flux and preventing the magnetic flux to be scattered, a rotor housing 290 surrounding the rotor core 210 to prevent the permanent magnet 280 from being separated, and the permanent magnet 280 forming the magnetic field.

The rotor core 210 may include a main core 220, a radial core 225, the magnetic flux concentration core 235, an inner coupling part 240, an inner magnetic flux leakage preventing part 250, an outer coupling part 245, an outer magnetic flux leakage preventing part 255, a permanent magnet seating part 230, and a coupling hole 260.

The main core 220 has a cylindrical shape and a shaft inserting hole 215 connected to the shaft 400 may be provided in the main core.

In addition, the main core 220 may form a framework of the rotor 200 to maintain the shape of the rotor 200 under a stress applied to the rotor 200 when the rotor 200 is rotated. In addition, the main core 220 provides a path for the magnetic field formed by the permanent magnet 280 to enable the magnetic flux to flow along the main core 220.

The radial core 225 may be coupled to the main core 220 in the state in which the radial core extends to an exterior in the radial direction which is perpendicular to the circumferential direction of the rotor 200. The radial core 225 may provide a passage for enabling the magnetic flux to flow in the magnetic field formed by a pair of permanent magnets 280 adjacent to the radial core 225, and may be electrically connected to the main core 220 to increase a q-axis inductance.

In addition, one radial core 225 may have a constant width so that a pair of adjacent permanent magnets 280 are arranged in parallel with each other, and the circumferential outer radial core 225 may have a width greater than that the circumferential inner radial core 225 so that a pair of adjacent permanent magnets 280 are disposed at a predetermined angle (for example, 20 degrees). In addition to that, various shapes of the radial core 225 for arranging a pair of permanent magnets 280 may be employed as an example of the shape of the radial core 225.

The magnetic field caused by the permanent magnets 280 disposed at both sides of the magnetic flux concentration core 235 is formed in the magnetic flux concentration core 235 so that the magnetic flux concentration core 235 guides the magnetic field to concentrate the magnetic flux.

Also, the magnetic flux concentration core 235 may have a fan shape as shown in FIG. 3. In addition, a radius in the fan shape may be the same as or different from that of the rotor 200.

The inner coupling part 240 reduces scattering of the magnetic flux concentration core 235 due to a centrifugal force generated from a center of the rotor 200 to an exterior when the rotor 200 is rotated. Specifically, the inner coupling part 240 is disposed between an inner side of the magnetic flux concentration core 235 and an outer side of the main core 220 and is coupled to the inner side of the magnetic flux concentration core 235 and the outer side of the main core 220. Accordingly, the inner coupling part 240 reduces displacement generated by the magnetic flux concentration core 235, which is moved outward by the centrifugal force, so that it is possible to reduce scattering of the magnetic flux concentration core 235.

The inner magnetic flux leakage preventing parts 250 may be placed at both sides of the inner coupling part 240 to prevent a leakage of the magnetic flux flowing into/flowing out of the permanent magnet 280. Specifically, the inner magnetic flux leakage preventing part 250 is provided between a radial inner portion of the permanent magnet 280, which faces in the radial direction of the rotor 220, and a radial outer portion of the main core 220, and is filled with non-magnetic material such as a plastic or water so that it is possible to prevent the magnetic flux formed by the permanent magnet 280 from leaking to the main core 220.

The outer coupling part 245 reduces scattering of the magnetic flux concentration core 235, the radial core 225, and the permanent magnet 280 due to the centrifugal force generated from the center of the rotor 200 to an exterior when the rotor 200 is rotated. Specifically, the outer coupling part 245 is placed between the radial core 225 and the magnetic flux concentration core 235 and is coupled to the radial core 225 and the magnetic flux concentration core 235. Accordingly, the outer coupling part 245 reduces displacement generated by the magnetic flux concentration core 235, the radial core 225, and the permanent magnet 280, which are moved outward by the centrifugal force, so that it is possible to reduce scattering of the magnetic flux concentration core 235, the radial core 225, and the permanent magnet 280.

If the mechanical reliability of the rotor 200 is high, the outer coupling part 245 may be omitted.

The outer magnetic flux leakage preventing part 255 may be placed outside of the permanent magnet 280 to prevent a leakage of the magnetic flux flowing into/flowing out of the permanent magnet 280. Specifically, the outer magnetic flux leakage preventing part 255 is provided between a radial outer portion of the permanent magnet 280 and an inner portion of the outer coupling part 245. Also, like in the inner magnetic flux leakage preventing part 250, the outer magnetic flux leakage preventing part is filled with a non-magnetic material so that it is possible to prevent the magnetic flux formed by the permanent magnet 280 from leaking to the main core 220.

In order to provide a path through which the magnetic flux flows and to have electrical conductivity, a soft magnetic material and a metal may be employed as a material for the main core 220, the magnetic flux concentration core 235, the inner coupling part 240, and the outer coupling part 245. In addition to that, a variety of materials which have conductivity and are not changed in the shape by an external stress may be employed as an example of the material for the main core 220, the magnetic flux concentration core 235, the inner coupling part 240, and the outer coupling part 245.

In proportion to a width, in addition, the inner coupling part 240 and the outer coupling part 245 provide a path through which the magnetic flux generated from the permanent magnet 280 flows, this width is set to a value equal to or less than the predetermined value. For example, a width W1 of the inner coupling part 240 and a width W4 of the outer coupling part 245 may be set to a value equal to or less than approximately 1 mm. In addition to that, various values of the widths for preventing a leakage of the magnetic flux and preventing deformation of the f 210 caused by the stress when the rotor is rotated at a high speed may be used as an example of the width W1 of the inner coupling part 240 and the width W4 of the outer coupling part 245.

Also, the radial core 225 and the main core 220 are set at a predetermined ratio to provide the path through which the magnetic flux flows.

The permanent magnet seating part 230 is located between the magnetic flux concentration core 235 and two radial cores 225, which are provided at both sides of the magnetic flux concentration core 235 and spaced apart from each other, to provide a space in which the permanent magnet 280 is magnetized.

As shown in FIG. 4, specifically, the permanent magnet seating part 230 is divided into a first permanent magnet seating part 230a and a second permanent magnet seating part 230b located at both sides of the magnetic flux concentration core 235. A recess having a size corresponding to a size of the permanent magnet 280 to be seated is formed on the permanent magnet seating part 230, and the permanent magnet 280 may be seated in the formed recess. The recess formed on the permanent magnet seating part 230 may have a width greater than widths of the inner magnetic flux leakage preventing part 250 and the outer magnetic flux leakage preventing part 255. In addition, the recess formed in the permanent magnet seating part 230 may be formed in parallel with the radial core 225 and may be formed at a predetermined angle between the permanent magnet seating part 230 and the radial core 225. The predetermined angle may have a value which is determined in advance according to an intensity of the magnetic flux to be concentrated and a q-axis inductance to be increased. For example, the predetermined angle may be equal to or less than approximately 20 degrees. Various angles determined in light of the intensity of the magnetic flux to be concentrated and the q-axis inductance to be increased may be employed as an example of the predetermined angle.

Besides, a variety of configurations for seating the permanent magnet 28 may be employed as the permanent magnet seating part 230.

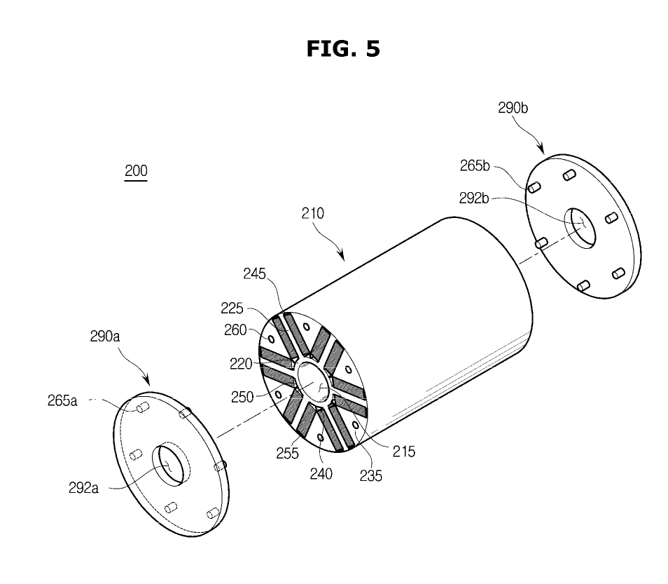

FIG. 5 shows an exterior of the rotor to which the rotor housing is coupled.

The coupling hole 260 is formed to correspond to a coupling protrusion 265 of the rotor housing 290 and to allow the rotor housing 290 to be coupled to the rotor core 210. As shown in FIG. 5, the coupling hole 260 is formed in the magnetic flux concentration core 235 and the coupling hole 260 may have a width greater than or the same as that of the coupling protrusion 265. In addition, the coupling hole 260 may have a cylindrical shape corresponding to the shape of the coupling protrusion 265 or may have a polygonal column shape.

The rotor housing 290 is coupled to the rotor core 210 to prevent the permanent magnet 280 magnetized on the permanent magnet seating part 230 from escaping to the outside of the rotor core 210. Also, the rotor housing 290 may be divided into the first rotor housing 290a and the second rotor housing 290b based on a horizontal axis.

A first coupling protrusion 265a corresponding to the shape of the coupling hole 260 may be provided on a connecting portion of the first rotor housing 290a, and a second coupling protrusion 265b corresponding to the shape of the coupling hole 260 may be provided on a connecting portion of the second rotor housing 290b.

Supporting holes 292 may be formed in centers of the first rotor housing 290a and the second rotor housing 290b, respectively, for enabling the shaft 400 connected to the shaft inserting hole 215 to be supported in the supporting holes. For supporting the shaft 400, in addition, a first supporting hole 292a formed on a center of the first rotor housing 290a may have a radius smaller than that of the shaft inserting hole 215 and a connecting portion of the first supporting hole 292a may have a radius smaller than that of the other portion of the first supporting hole 292a. However, a radius of a second supporting hole 292b formed at a center of the second rotor housing 290b at which the shaft 400 is connected to a device requiring the rotational force may be the same as or greater than that of the shaft inserting hole 215.

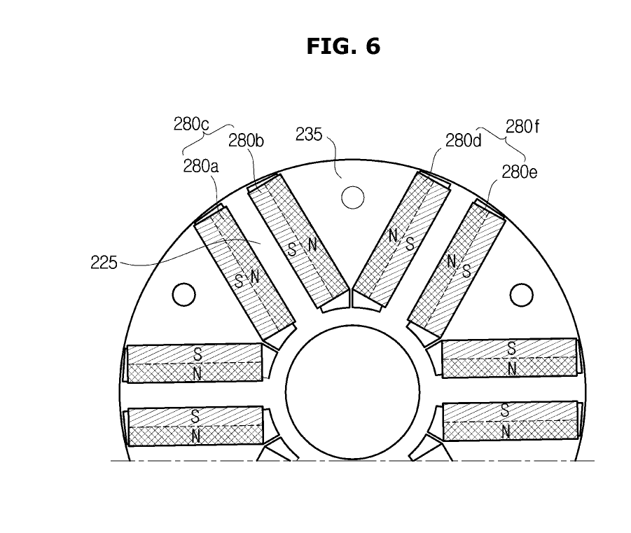

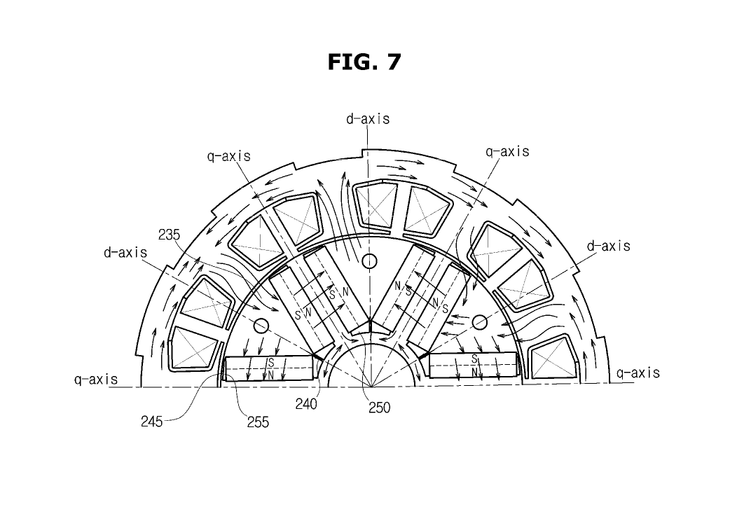

Hereinafter, an embodiment of the magnetization and magnetic flux concentration of a plurality of permanent magnets with be described with reference to FIG. 6 and FIG. 7.

FIG. 6 shows a concept of magnetization directions of a plurality of permanent magnets 280 magnetized to the rotor and FIG. 7 shows a concept that magnetic fluxes of a plurality of permanent magnets are concentrated into the magnetic flux concentration core.

As shown in FIG. 7, the permanent magnets 280 are magnetized to the permanent magnet seating part 230 such that the magnetic flux is concentrated to the magnetic flux concentration core 235 on the d-axis to allow the magnetic flux concentration core 235 from the pole of the rotor 200 and the magnetic flux may flow in the radial core 225 on the q-axis to another adjacent permanent magnet 280.

Specifically, as shown in FIG. 6, the permanent magnet 280 is magnetized such that a plurality of permanent magnets 280 placed at both sides of the magnetic flux concentration core 235 are symmetrically magnetized to allow the same pole of the permanent magnets to face the magnetic flux concentration core 235 and a plurality of permanent magnets 280 placed at both sides of the radial core 225 to allow different poles of the permanent magnets to face the radial core 225 to form the magnetic flux with the same direction.

For example, assuming that a combination of a first permanent magnet 280a and a second permanent magnet 280b, which are adjacent to one radial core 225, is called a first permanent magnet combination 280c and a combination of a third permanent magnet 280d and a fourth permanent magnet 280e, which are adjacent to another radial core 225, is called a second permanent magnet combination 280f, the second permanent magnet 280b and the third permanent magnet 280d which are adjacent to the magnetic flux concentration core 235 may be magnetized such that S pole and N pole of the second permanent magnet 280b are sequentially disposed in the clockwise circumferential direction and N pole and S pole of the third permanent magnet 280d are sequentially disposed in the clockwise circumferential direction. In addition, the first permanent magnet 280a and the second permanent magnet 280b which are placed at both sides of the radial core 225 may be magnetized such that S pole and N pole are sequentially disposed in the clockwise circumferential direction.

Even though the ferrite magnet having the residual magnetic flux density and the coercive force which are lower than those of the rare earth magnet is employed in the method for magnetizing the permanent magnet 280 concentrating the magnetic flux to the magnetic flux concentration core 235, the output which is similar to that obtained using the rare earth magnet can be obtained when the motor is rotated at a low speed. As compared with the spoke type motor, in addition, the magnetizing method in which the permanent magnets 280 having the same magnetic flux direction are disposed at both sides of the radial core 225 can increase the q-axis inductance to obtain a high output when the motor is rotated at a low speed.

The basis on which the motor can obtain a high output when rotated at low and high speeds due to the magnetization directions of the radial core 225, the magnetic flux concentration core 235 and the permanent magnet 280 will be described with reference to Equation 1 to Equation 4 below.

Tₜ=Tₘ+Tᵣ [Equation 1]

Equation 1 is an equation representing a relation among a total torque, a reaction torque and a reluctance torque generated by the motor 1. In the variables in Equation 1, the total torque may be represented as Tₜ, the reaction torque may be represented as Tₘ, and the reluctance torque may be represented as Tᵣ.

As expressed in Equation 1, the total torque generated by the motor 100 may be represented as the sum of the reaction torque and the reluctance torque.

$${T}_{m} = \frac{P}{2} {ϕ}_{α} {i}_{q} \qquad [ Equation 2 ]$$

Equation 2 is an equation for calculating the reaction torque. In the variables in Equation 2, the number of poles may be represented as P, a magnetic flux interlinkage formed by the permanent magnet 280 may be represented as φₐ, and a q-axis current may be represented as i_{q}.

The reaction torque is generated by an interaction of the magnetic flux of the permanent magnet 280 and the current, and the reaction torque may be determined by the magnetic flux interlinkage formed by the permanent magnet 280 as represented in Equation 2.

$${T}_{r} = \frac{P}{2} ( {L}_{q} - {L}_{d} ) {i}_{q} {i}_{d} \qquad [ Equation 3 ]$$

Equation 3 is an equation for calculating the reluctance torque. In the variables in Equation 3, a q-axis inductance may be represented as L_{q}, a d-axis inductance may be represented as L_{d} and a d-axis current flowing in the coil 340 of the stator 300 may be represented as i_{d}.

As expressed in Equation 3, the reluctance torque may be determined by a difference between the q-axis inductance and the d-axis inductance of the inductance of the stator 300, which is represented as the sum of a leakage inductance and a magnetizing inductance.

Here, the q-axis inductance and the d-axis inductance are values calculated by calculating a self-inductance and a mutual inductance to calculate the inductance of the stator 300 and converting the calculated inductance of the stator 300 into a d-q axis coordinate system which is an angular velocity aspect of the rotor 200

$${T}_{t} = \frac{P}{2} \{ {ϕ}_{α} {i}_{q} + ( {L}_{d} - {L}_{q} ) {i}_{q} {i}_{d} \} \qquad [ Equation 4 ]$$

Equation 4 is an equation for calculating the total torque, which is obtained by substituting Equation 1 with Equations 2 and 3 and arranging terms.

In Equation 4, the first term in the right hand side relates to the reaction torque and the second term of the right hand side relates to the reluctance torque.

Because a current phase angle is small in a constant torque region in which a speed of the rotor is less than a base speed, the d-axis current flowing through the coil of the stator is almost zero (0) so that the d-axis current may have a less effect on the reluctance torque. Therefore, assuming that a maximum torque per ampere control (MTPA) is performed at a speed which is equal to or less than the base speed, because an influence of the reaction torque is low, the magnetic flux is concentrated on the magnetic flux concentration core 235 to the increase magnetic flux interlinkage so that even though the ferrite magnet is employed, it is possible to obtain the torque which is similar to that obtained by the rare earth magnet.

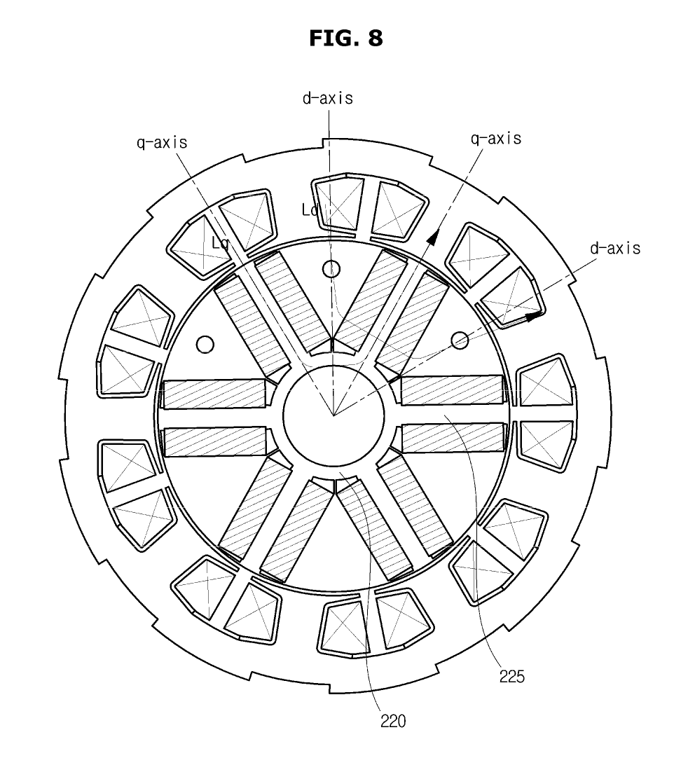

On the contrary, a method for increasing the torque at the speed equal to or greater than the base speed will be described with reference to FIG. 8.

FIG. 8 shows a concept that the q-axis inductance is increased by the radial core.

In a constant power region in which a speed is equal to or larger than the base speed, an interior permanent magnet motor is driven under a voltage and current limiting condition, and a flux weakening control is performed.

In the permanent magnet motor 100, the magnetic flux of the field system is generated from the permanent magnet 280 and the magnetic flux cannot be directly controlled. The flux weakening control is a control method in which a current of the d-axis stator 300 corresponding to the magnetic flux component flows to generate the magnetic flux in the direction opposite to the flux direction of the permanent magnetic flux to reduce a magnitude of the useful magnetic flux of an air-gap to allow an induced voltage caused by a high speed rotation to be satisfied with a limiting voltage. For example, by adjusting a current phase angle of the negative d-axis current, it is possible to offset the magnetic flux generated from the permanent magnet 280.

In this case, the q-axis current is reduced by adjusting the current phase angle to reduce an influence of the reaction torque. In the constant output region, however, an influence of the reluctance torque may be increased. In order to increase the reluctance torque under the voltage and current limiting condition, therefore, a difference between the q-axis inductance and the d-axis inductance should be increased.

In general, in the interior permanent magnet motor 100 having a magnetic salient pole, the q-axis inductance is greater than the d-axis inductance due to the permanent magnet 280 inserted in the rotor 200. Therefore, if the radial core 225 is disposed as shown in FIG. 8, the magnetic flux caused by the q-axis current does not pass through the permanent magnet 280, but passes though the radial core 225 so that the q-axis inductance may be increased to increase the reluctance torque.

As a result, it is possible to obtain a high torque in the case in which a speed of the rotor is greater than the base speed.

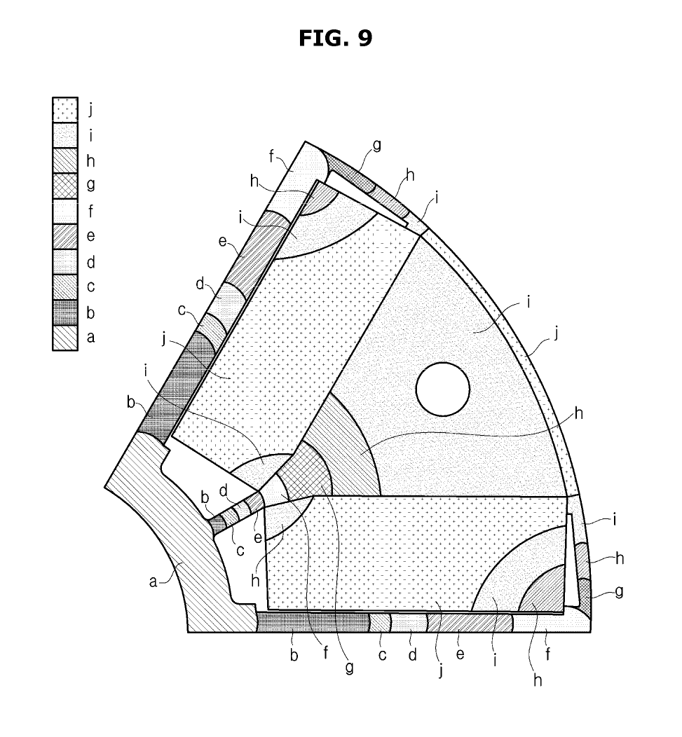

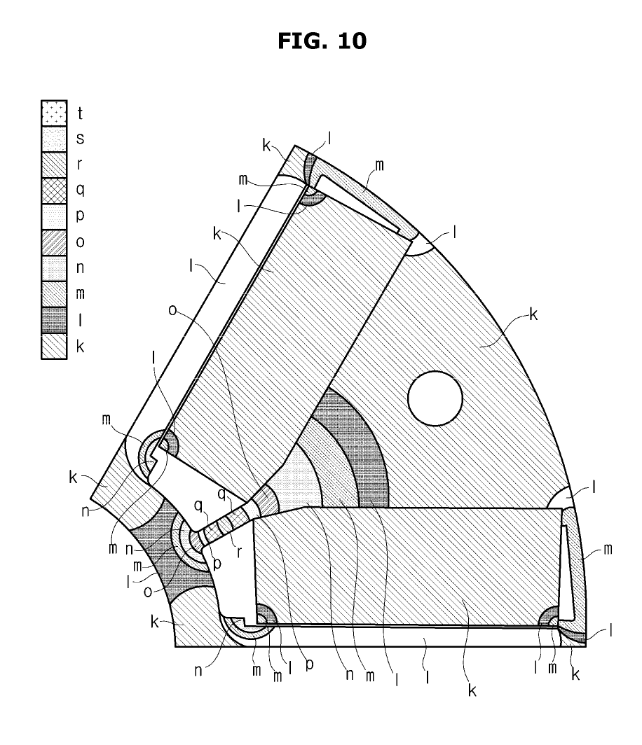

Hereinafter, an embodiment of the rotor will be described with reference to FIG. 9 and FIG. 10.

FIG. 9 shows displacement caused by the centrifugal force of the rotor in the simulation and FIG. 10 shows a stress caused by the centrifugal force of the rotor in the simulation.

The simulation employs the ANSYS which structurally analyzes a scattering phenomenon caused by the centrifugal force and represents the displacement and the stress of the rotor 200 when the rotor 200 having the radius of 44 mm is rotated at a speed of 9.6 kRpm.

In FIG. 9, the first region “a” indicates the range in which displacement is equal to or less than 0 μm, the second region “b” indicates the range in which a displacement is equal to or less than 0.6927 μm, the third region “c” indicates the range in which a displacement is equal to or less than 1.385 μm, the fourth region “d” indicates the range in which a displacement is equal to or less than 2.078 μm, the fifth region “e” indicates the range in which a displacement is equal to or less than 2.271 μm, the sixth region “f” indicates the range in which a displacement is equal to or less than 3.464 μm, the seventh region “g” indicates the range in which a displacement is equal to or less than 4.156 μm, the eighth region “h” indicates the range in which a displacement is equal to or less than 4.849 μm, the ninth region “i” indicates the range in which a displacement is equal to or less than 5.542 μm, and the tenth region “j” indicates the range in which a displacement is equal to or less than 6.235 μm.

In FIG. 10, the eleventh region “k” indicates the range in which a stress is equal to or less than 0 MPa, the twelfth region “I” indicates the range in which a stress is equal to or less than 24 MPa, the thirteenth region “m” indicates the range in which a stress is equal to or less than 49 MPa, the fourteenth region “n” indicates the range in which a stress is equal to or less than 73 MPa, the fifteenth region “o” indicates the range in which a stress is equal to or less than 98 MPa, the sixteenth region “p” indicates the range in which a stress is equal to or less than 122 MPa, the seventeenth region “q” indicates the range in which a stress is equal to or less than 147 MPa, the eighteenth region “r” indicates the range in which a stress is equal to or less than 171 MPa, the nineteenth region “s” indicates the range in which a stress is equal to or less than 196 MPa, and the twentieth region “t” indicates the range in which a stress is equal to or less than 220 MPa.

As shown in FIG. 9, a maximum displacement is approximately 6.235 μm when the rotor 200 is rotated at a speed of 9.6 kRpm, and the stress applied to the outer coupling part 245 of the rotor 200 is 158 MPa as shown in FIG. 10.

In this simulation, when the stress which is equal to or greater that the specific value is applied, a yield stress of the rotor core 210, which is the limiting value at which a deformation is rapidly increased, is 440 MPa, while the stress applied to the inner coupling part 240 is 158 MPa, which is one third of the yield stress, when the rotor is rotated at the speed of 9.6 kRpm. From the above simulation, therefore, it can be found that because the inner coupling part 240 is coupled between the main core 220 and the magnetic flux concentration core 235, scattering of the rotor 200 is prevented and a mechanical reliability of the rotor 200 is increased.

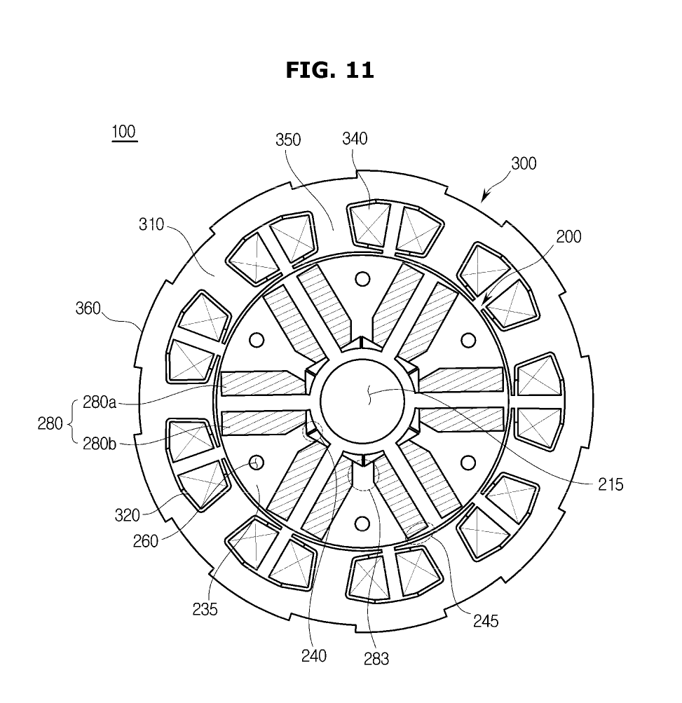

Hereinafter, an embodiment of the rotor will be described with reference to FIG. 11 to FIG. 13.

FIG. 11 shows a cross section of the motor including a magnetization guide part and a chamfering part.

The motor 100 may include the motor housing 190, the stator 300, the shaft 400, and the rotor 200.

The motor housing 190, the stator 300, and the shaft 400 in FIG. 11 may be the same as or different from the motor housing 190, the stator 300, and the shaft 400 in FIG. 2.

The rotor 200 is a device in which the attractive force and the repulsive force are generated between the magnetic field caused by the permanent magnet 280 and the magnetic field formed on the teeth 350 of the stator 300 to obtain the rotational force of the motor 100. The rotor 200 shown in FIG. 11 may be the same as or different from the rotor 200 shown in FIG. 2.

In addition, the rotor 200 may include a circumferential inner magnetization part 283.

The circumferential inner magnetization part 283 is a configuration for allowing a magnetization flux to flow to the circumferential inner portion of the permanent magnet 280 when the permanent magnet is magnetized. The circumferential inner magnetization part 283 may include a magnetization guide part 287 of the rotor core 210 and a chamfering part 285 of the permanent magnet 280.

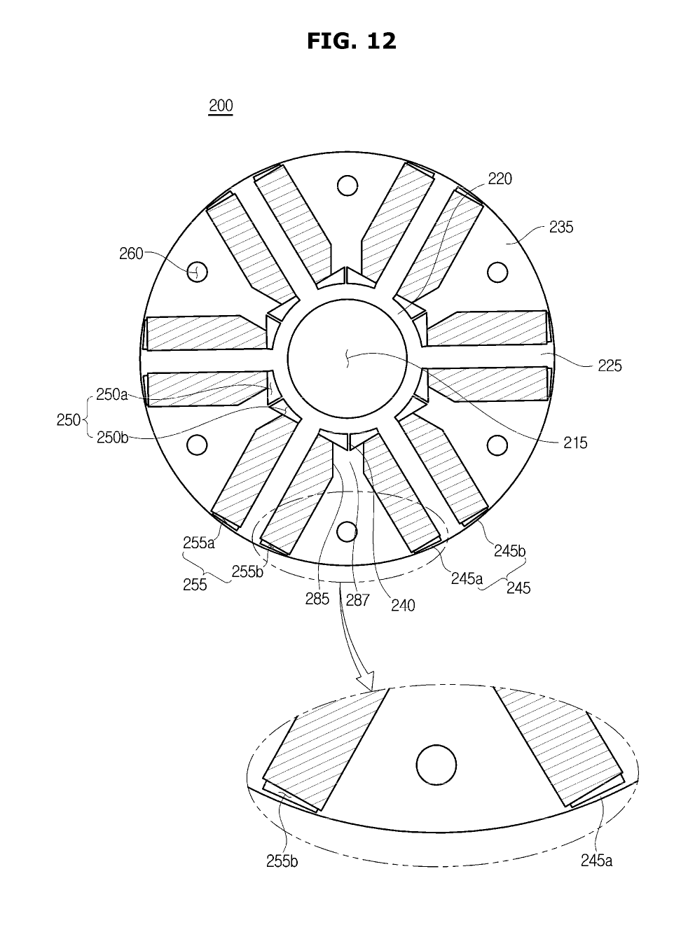

The circumferential inner magnetization part 283 will be described in detail below with reference to FIG. 12 to FIG. 16.

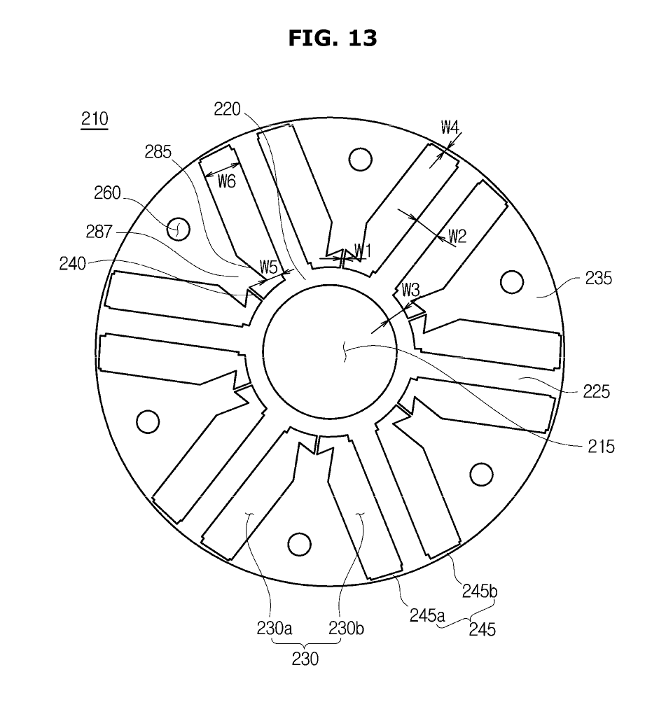

FIG. 12 shows a cross-section of the rotor including the chamfering part and the magnetization guide part, and FIG. 13 shows a cross-section of the rotor core including the magnetization guide part.

The rotor 200 may include the rotor core 210 acting as a passage of the magnetic field formed by the permanent magnet 280, concentrating the magnetic flux and preventing the magnetic flux to be scattered, the rotor housing 290 surrounding the rotor core 210 to prevent the permanent magnet 280 from being separated, and the permanent magnet 280 forming the magnetic field.

And, the rotor core 210 may include the main core 220, the radial core 225, the magnetic flux concentration core 235, the inner coupling part 240, the inner magnetic flux leakage preventing part 250, the outer coupling part 245, the outer magnetic flux leakage preventing part 255, the permanent magnet seating part 230, the coupling hole 260, and the magnetization guide part 287.

The main core 220, the radial core 225, the magnetic flux concentration core 235, the inner coupling part 240, the inner magnetic flux leakage preventing part 250, the outer coupling part 245, the outer magnetic flux leakage preventing part 255, and the coupling hole 260 may be the same as or different from the main core 220, the radial core 225, the magnetic flux concentration core 235, the inner coupling part 240, the inner magnetic flux leakage preventing part 250, the outer coupling part 245, the outer magnetic flux leakage preventing part 255 and the coupling hole 260 shown in FIG. 3 and FIG. 4.

The permanent magnet seating part 230 is located between the magnetic flux concentration core 235 and two radial cores 225, which are provided at both sides of the magnetic flux concentration core 235 and spaced apart from each other, to provide a space in which the permanent magnet 280 is magnetized.

As shown in FIG. 13, specifically, the permanent magnet seating part 230 is divided into the first permanent magnet seating part 230a and the second permanent magnet seating part 230b located at both sides of the magnetic flux concentration core 235. The recess having a size corresponding to a size of the permanent magnet 280 to be seated is formed on the permanent magnet seating part 230, and the permanent magnet 280 may be seated in the formed recess. The recess formed on the permanent magnet seating part 230 may have a width greater than widths of the inner magnetic flux leakage preventing part 250 and the outer magnetic flux leakage preventing part 255. In addition, the recess formed in the permanent magnet seating part 230 may be formed in parallel with the radial core 225 and may be formed at a predetermined angle between the permanent magnet seating part 230 and the radial core 225. The predetermined angle may be a value which is determined in advance according to an intensity of the magnetic flux to be concentrated and the q-axis inductance to be increased. For example, the predetermined angle may be equal to or less than 20 degrees. Various angles determined in light of the intensity of the magnetic flux to be concentrated and the q-axis inductance to be increased may be employed as an example of the predetermined angle.

In addition, according to the shape of the permanent magnet 280 to be seated, the permanent magnet seating part 230 may have a chamfering part formed on an inner edge thereof adjacent to the magnetic flux concentration core 235. Specifically, an inside edge of the first permanent magnet seating part 230a and an inside edge of the second permanent magnet seating part 230b, which faces the inside edge of the first permanent magnet seating part 230a, may be linearly chamfered as shown in FIG. 13 so that the permanent magnet seating part 230 may have a trapezoid shape. Also, the inside edges of the first permanent magnet seating part 230a and the second permanent magnet seating part 230b may be roundly chamfered so that the permanent magnet seating part 230 may have a shape which is the same as one of four parts obtained by dividing an ellipse with respect to a major axis and a minor axis. Therefore, a width W5 of a circumferential inner portion of the permanent magnet seating part 230 may be smaller than a width W6 of a circumferential outer portion (W5<W6).

Various shapes for seating the permanent magnet 280 may be used as one example of the permanent magnet seating part 230.

The magnetization guide part 287 is placed between the magnetic flux concentration core 235 and the inner coupling part 240 to allow the magnetization magnetic flux supplied by a magnetizing yoke to flow from an outer circumference surface of the rotor to a circumferential inner portion of the permanent magnet 280 of the rotor. In other words, due to the shape of the magnetic flux concentration core 235 in which a width is gradually reduced toward a radial inner portion, the magnetizing magnetic flux supplied from the outer circumferential surface of the magnetic flux concentration core 235 is mainly supplied to a circumferential outer portion of the permanent magnet 280. However, due to the above configuration, the magnetization guide part 287 may guide the magnetizing magnetic flux to a circumferential inner portion to supply the magnetizing magnetic flux to a circumferential inner portion of the permanent magnet 280.

The magnetization guide part 287 is formed such that a width of a radial outer portion is the same as a width of a radial inner portion. Therefore, a center of the magnetization guide part may pass through a center of the rotor core 210 together with the radial core 225 and the inner coupling part 240. In addition, the magnetization guide part 287 is formed such that the radial outer portion has a width smaller than a width of the radial inner portion. Therefore, the magnetization guide part can guide the magnetizing magnetic flux supplied from an outer circumference edge of the rotor core 210 to allow the magnetizing magnetic flux to be uniformly supplied to a circumferential inner portion of the rotor core 210.

The rotor housing 290 may be the same as or different from the rotor housing 290 shown in FIG. 3 and FIG. 4.

The permanent magnet 280 generates the magnetic field, and the attractive force and the repulsive force are acted between the magnetic field of the permanent magnet and the magnetic field formed by the coil 340 to generate the rotational force by which the rotor 200 is rotated. In addition, the permanent magnet 280 is magnetized as described with reference to FIG. 6 and FIG. 7 to enable the magnetic flux to be concentrated on the magnetic flux concentration core 235.

Also, like the shape of the permanent magnet seating part 230, an inner edge of the permanent magnet 280, which is adjacent to the magnetic flux concentration core 235, may be chamfered so that a circumferential inner portion has a width smaller than a width of a circumferential outer portion.

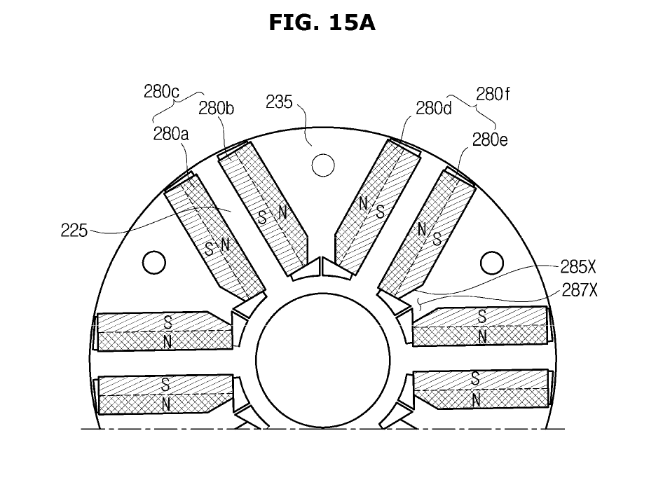

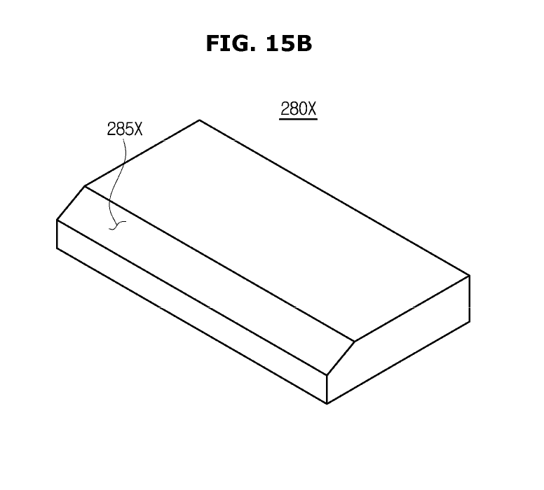

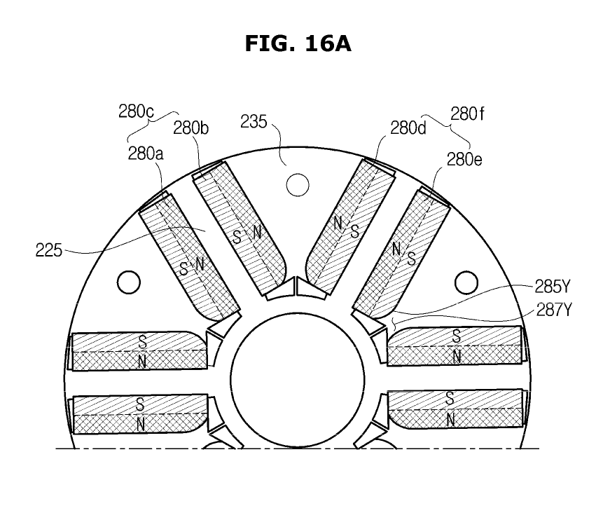

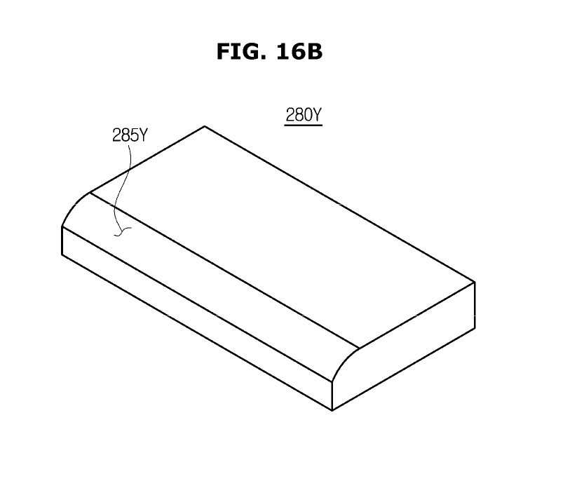

The shape in which the inner edge of the permanent magnet 280, which is adjacent to the magnetic flux concentration core 235, is chamfered will be described in detail with reference to FIG. 15 and FIG. 16.

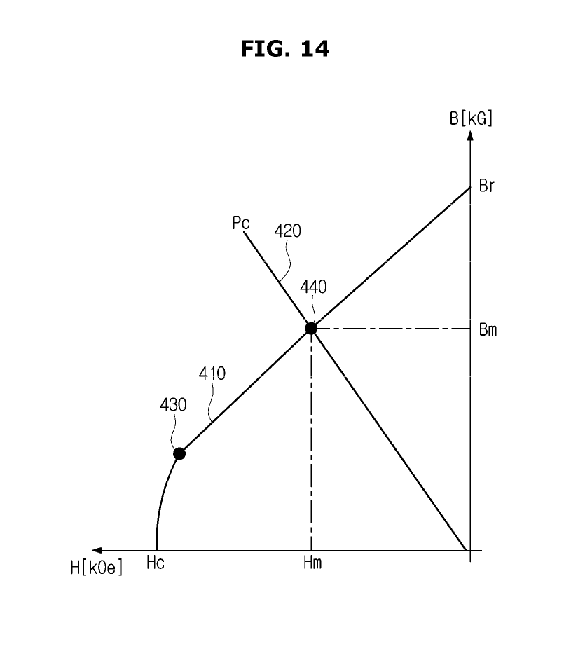

An embodiment for the thickness and shape of the permanent magnet will be described below with reference to FIG. 14.

FIG. 14 shows a graph showing a process for determining an operating point of the motor through a permeance coefficient.

FIG. 14 shows a demagnetization characteristic curve of the permanent magnet 280, in the case in which the magnetic flux density in the demagnetization characteristic curve is zero (0), an open circuit in which both poles of the permanent magnet 280 are opened is formed. In this case, because there is no magnetic flux flowing to an exterior, the magnetic field strength is “Hc”, at this time, the magnetic field strength is called a coercive force.

In the case in which the magnetic field strength of the characteristic curve is zero (0), a closed circuit in which keepers with infinite permeance are connected to both poles of the permanent magnet 280 is formed. In this case, the magnetic flux density is “Br”, at this time, the magnetic flux density is called a maximum magnetic flux density.

In addition, FIG. 14 shows an operating line of the motor, the permeance coefficient Pc indicating a gradient of the operating line is calculated by FIG. 5 to FIG. 9.

$$\frac{{H}_{m} {l}_{m}}{{H}_{g} {l}_{g}} = f \qquad [ Equation 5 ]$$

Equation 5 is an equation for representing a relation between a magnetic field strength of the permanent magnet 280 and a magnetic field strength of the air-gap. In the variables in Equation 5, the magnetic field strength of the permanent magnet 280 may be represented as Hₘ, the magnetic field strength of the air-gap may be represented as H_{g}, a thickness of the permanent magnet 280 may be represented as lₘ, a thickness of the air-gap may be represented as l_{g} and a loss coefficient of magnetomotive force or a reluctance coefficient may be represented as f.

Through Equation 5 and the Ampere circuital law in a magnetic circuit, the equation regarding the magnetomotive force may be expressed as Equation 6.

$${H}_{m} = - f \frac{{l}_{g}}{{l}_{m}} {H}_{g} \qquad [ Equation 6 ]$$

Equation 6 is an equation for representing the magnetic field strength of the permanent magnet 280, which is obtained by arranging FIG. 5 and an equation regarding the magnetomotive force induced from the Ampere circuital law. From Equation 6, it can be found that the magnetic field strength of the permanent magnet 280 is proportional to the reluctance coefficient, a thickness of the air-gap and the magnetic field strength of the air-gap, and is inversely proportional to a thickness of the permanent magnet 280.

$$\frac{{B}_{m} {A}_{m}}{{B}_{g} {A}_{g}} = F \qquad [ Equation 7 ]$$

Equation 7 is an equation for representing the magnetic flux density of the permanent magnet 280 and the magnetic flux density of the air-gap. In the variables in Equation 7, the magnetic flux density of the permanent magnet 280 may be represented as Bₘ, the magnetic flux density of the air-gap may be represented as B_{g}, a sectional area of the permanent magnet 280 may be represented as Aₘ, a sectional area of the air-gap may be represented as A_{g}, and a leakage coefficient of the magnetic flux or a ratio between the magnetic flux generated in the permanent magnet and the magnetic flux density of the air-gap may be represented as F.

Equation 7 and a condition of continuity of the magnetic flux in the magnetic circuit having the permanent magnet 280 may be expressed as Equation 8.

$${B}_{m} = F \frac{{A}_{g}}{{A}_{m}} {H}_{g} \qquad [ Equation 8 ]$$

Equation 8 is an equation for representing the magnetic flux density of the permanent magnet 280, which is obtained by arranging Equation 7 and an equation regarding the condition of continuity of the magnetic flux in the magnetic circuit. From Equation 8, it can be found that the magnetic flux density of the permanent magnet 280 is proportional to the leakage coefficient of the magnetic flux, a sectional area of the air-gap and the magnetic field strength of the air-gap, and is inversely proportional to a sectional area of the permanent magnet 280.

$${P}_{c} = \frac{{B}_{m}}{{H}_{m}} = - \frac{F}{f} \frac{{A}_{g}}{{A}_{m}} \frac{{l}_{m}}{{l}_{g}} = - k \frac{{A}_{g}}{{A}_{m}} \frac{{l}_{m}}{{l}_{g}} \qquad [ Equation 9 ]$$

Equation 9 is an equation for calculating the permeance coefficient, which is obtained by arranging Equation 6 and Equation 8. In the variables in Equation 9, the permeance coefficient may be represented as P_{c}, and a proportional constant may be represented as k.

From Equation 9, it can be found that the permeance coefficient is proportional to the proportional constant, the sectional area of the air-gap and a thickness of the permanent magnet 280, and is inversely proportional to the sectional area of the permanent magnet 280 and the thickness of the air-gap. Here, in general, it is difficult to change the proportional constant, the sectional area of the permanent magnet 280, the sectional area, and the thickness of the air-gap in the motor 100. Therefore, the permeance coefficient may be determined according to the thickness of the permanent magnet 280.

In this case, the operating point of the motor 100 is the point at which the operating line of the motor 100 meets the demagnetization characteristic curve, the operating point in the magnetic circuit is changed by an external influence and an operation characteristic of the motor 100 is thus changed.

Specifically, the operating point may be changed by applying an external magnetic field, a change of the permeance coefficient, and a change of an operating temperature. In the case in which the operating point is changed by a change in the permeance coefficient, as known from Equation 9, if the permanent magnet 280 is thin and an absolute value of the permeance coefficient is thus reduced, the operating point is moved to a left lower end of FIG. 14. In this case, once the permanent magnet 280 is thin and the operating line passes a knee point of the demagnetization characteristic curve, an irreversible demagnetization by which the motor 100 cannot be restored to the original operating point of the permanent magnet 280 is generated. Therefore, in order to prevent generation of the irreversible demagnetization of the motor 100, the permanent magnet 280 should have the thickness which is equal to or greater than a specific thickness.

If the permanent magnet 280 is thick, the magnetic torque is increased and likelihood of generation of the irreversible demagnetization is reduced. However, because the thicker the permanent magnet 280 becomes, the narrower a width of the radial core 225 becomes, the q-axis inductance is reduced so that the reluctance torque is reduced and the total torque is thus reduced. In addition, because the permanent magnet 280 becomes thicker, a width of the magnetic flux concentration core 235 becomes narrower, the magnetization magnetic flux supplied by the magnetizing yoke is not uniformly supplied to the permanent magnet 280 placed on a circumferential inner portion of the rotor core 210. Therefore, a non-magnetization region is generated on the permanent magnet 280 of the circumferential inner portion of the rotor core 210. Consequently, in order to prevent the non-magnetization region from being generated on the permanent magnet 280 of the motor 100, the permanent magnet 280 should have the thickness which is equal to or less than the specific value.

Therefore, it is possible to solve the above problems through the chamfering part 285 formed by chamfering an edge of a circumferential inner portion of the permanent magnet 280, which is adjacent to the magnetic flux concentration core 235.

Specifically, in order to prevent a generation of the irreversible demagnetization occurred when the permeance coefficient is reduced due to a reduction of the thickness of the permanent magnet 280 and the operating point passes the knee point, the circumferential outer portion of the permanent magnet 280 may have the thickness which is equal to or greater than that by which the irreversible demagnetization is not generated.

In addition, by chamfering the edge of the circumferential inner portion of the permanent magnet 280, which is adjacent to the magnetic flux concentration core 235, the circumferential inner portion of the permanent magnet may be thicker that the circumferential outer portion. Therefore, the magnetization guide part 287 formed to correspond to the shape of the permanent magnet 280 may guide the magnetizing magnetic flux supplied from the outer circumference surface of the rotor core 210 to the circumferential outer portion of the rotor core 210 to prevent the non-magnetization region from being generated on the circumferential inner portion of the permanent magnet 280.

In addition, the rotor core 210 may have the coupling hole which has not a circular shape, but has a wedge shape in which a curved portion faces an outer circumference surface and a non-curved portion faces an inner circumference surface, to prevent the non-magnetization region and the irreversible demagnetization from be generated.

Hereinafter, the shape of the permanent magnet 280 will be described in detail with reference to FIG. 15 and FIG. 16.

FIG. 15a shows the concept of the magnetization direction of a plurality of permanent magnets magnetized to the rotor, and FIG. 15b shows an exterior of the permanent magnet including a planar chamfering part.

As shown in FIG. 15a, a permanent magnet 280X is magnetized such that a plurality of permanent magnets 280X placed at both sides of the magnetic flux concentration core 235 are symmetrically magnetized to allow the same pole of the permanent magnets to face the magnetic flux concentration core 235 and a plurality of permanent magnets 280X placed at both sides of the radial core 225 to allow different poles of the permanent magnets to face the radial core 225 to form the magnetic flux with the same direction.

For example, assuming that a combination of a first permanent magnet 280a and a second permanent magnet 280b, which are adjacent to one radial core 225, is called a first permanent magnet combination 280c and a combination of a third permanent magnet 280d and a fourth permanent magnet 280e, which are adjacent to another radial core 225, is called a second permanent magnet combination 280f, the second permanent magnet 280b and the third permanent magnet 280d which are adjacent to the magnetic flux concentration core 235 may be magnetized such that S pole and N pole of the second permanent magnet 280b are sequentially disposed in the clockwise circumferential direction and N pole and S pole of the third permanent magnet 280d are sequentially disposed in the clockwise circumferential direction. In addition, the first permanent magnet 280a and the second permanent magnet 280b which are placed at both sides of the radial core 225 may be magnetized such that S pole and N pole are sequentially disposed in the clockwise circumferential direction.

In addition, a material for the permanent magnet 280X may be the same as or different from that of the permanent magnet 280.

In addition, the permanent magnet 280X may have a chamfering part 285X as shown in FIG. 15a and FIG. 15b.

As described with reference to FIG. 14, in the motor 100 including the block shaped permanent magnet 280X, if the permanent magnet 280X is thin, the irreversible demagnetization is generated and if the permanent magnet 280X is thick, the non-magnetization is generated on the circumferential inner portion of the permanent magnet 280X of the rotor 200. However, the chamfering part 285X can reduce generations of the irreversible demagnetization and the non-magnetization on the permanent magnet as described above.

Specifically, although the thickness of the circumferential inner portion of the permanent magnet 280X including the chamfering part 285X is reduced to a value which is less than the specific value, this is caused by the chamfering part 285X provided at the circumferential inner portion which is adjacent to the magnetic flux concentration core 235. Due to the above, the thickness of the circumferential outer portion of the permanent magnet 280X is equal to or greater than the specific value. As a result, it is possible to secure resistance force against the demagnetization and reduce a leakage magnetic flux. Therefore, it is possible to prevent the operating point of the motor 100 from passing through the knee point and the irreversible demagnetization from be generated.

In addition, although the thickness of the circumferential outer portion of the permanent magnet 280X including the chamfering part 285X is increased to the value greater than the specific value, the thickness of the circumferential inner portion of the permanent magnet 280X is not increased to the value equal to or greater than the specific value by the chamfering part 285X provided at the circumferential inner portion which is adjacent to the magnetic flux concentration core 235. Also, although the circumferential outer portion of the permanent magnet 280X is thick, because the magnetizing magnetic flux easily enters the circumferential outer portion, the non-magnetization region may not be generated on the permanent magnet 280X.

The chamfering part 285X shown in FIG. 15a and FIG. 15b may be linearly inclined toward one face of the magnetic permanent magnet 280X, which is adjacent to an inner circumferential face of the rotor 200, to reduce the thickness of the circumferential inner portion of the permanent magnet 280X. Therefore, as shown in FIG. 15a, the chamfering part 285X may have a planar face.

In addition, the chamfering part 285X may have one planar face as shown in FIG. 15b or may have a plurality of planar faces.

A chamfering degree (for example, a ratio of a width and a length) of the chamfering part 285X formed on the edge of the circumferential inner portion which is adjacent to the magnetic flux concentration core 235 may be determined by dimensions of the rotor 200 and the permanent magnet 280X, an output of the motor 100, and the like. In addition to that, another variable may be employed as an example determining the chamfering degree of the chamfering part 285X.

FIG. 16a shows a concept of the magnetization direction of a plurality of permanent magnets magnetized to the rotor, and FIG. 16b shows an exterior of the permanent magnet including a rounded chamfering part.

A kind, a material, and a magnetization direction of the permanent magnet 280Y shown in FIG. 16a and FIG. 16b may be the same as or different from those of the permanent magnet 280X shown in FIG. 15a and FIG. 156b.

In addition, the permanent magnet 280Y may have a chamfering part 285Y as shown in FIG. 16a and FIG. 16b.

As described with reference to FIG. 14, in the motor 100 including the block shaped permanent magnet 280Y, if the permanent magnet 280Y is thin, the irreversible demagnetization is generated and if the permanent magnet 280Y is thick, the non-magnetization is generated on the circumferential inner portion of the permanent magnet 280Y of the rotor 200. However, the chamfering part 285Y can reduce generations of the irreversible demagnetization and the non-magnetization as above.

Specifically, although the thickness of the circumferential inner portion of the permanent magnet 280 including the chamfering part 285Y is reduced to a value which is equal to or less than the specific value, this is caused by the chamfering part 285Y provided at the circumferential inner portion which is adjacent to the magnetic flux concentration core 235. Due to the above, the thickness of the circumferential outer portion of the permanent magnet 280Y is equal to or greater than the specific value. As a result, it is possible to secure a resistance force against the demagnetization and reduce a leakage magnetic flux. Therefore, it is possible to prevent the operating point of the motor 100 from passing through the knee point and the irreversible demagnetization from be generated.

In addition, although the thickness of the circumferential outer portion of the permanent magnet 280Y including the chamfering part 285Y is increased to the value equal to or greater than the specific value, the thickness of the circumferential inner portion of the permanent magnet 280Y is not increased to the value equal to or greater than the specific value by the chamfering part 285Y provided at the circumferential inner portion which is adjacent to the magnetic flux concentration core 235. Also, although the circumferential outer portion of the permanent magnet 280Y is thick, because the magnetizing magnetic flux easily enters the circumferential outer portion, the non-magnetization region may not be generated on the permanent magnet 280Y.

The chamfering part 285Y shown in FIG. 16a and FIG. 16b may be roundly inclined toward one face of the magnetic permanent 280Y, which is adjacent to an inner circumferential face of the rotor 200, to reduce the thickness of the circumferential inner portion of the permanent magnet 280X. Therefore, as shown in FIG. 16a, the chamfering part 285Y may have a curved face.

In addition, a chamfering degree (for example, a curvature) of the chamfering part 285Y formed on the edge of the circumferential inner portion which is adjacent to the magnetic flux concentration core 235 may be determined by dimensions of the rotor 200 and the permanent magnet 280Y, the output of the motor 100 and the like. In addition to the above, another variable may be employed as one example determining the chamfering degree of the chamfering part 285Y.

According to the above-described rotor and the motor using the same, it is possible to increase a driving force at a low speed by concentrating the magnetic flux, increase a driving force at a high speed by increasing the inductance, and prevent scattering of the rotor caused by a centrifugal force at a high speed.

The above description exemplarily describes the technical spirit of the present disclosure, and by those skilled in the technical field to which the present disclosure pertains can be variously changed, modified and substituted without departing from the principles and spirit of the disclosure. Therefore, the embodiment disclosed herein and the accompanying drawing do not limit the technical spirit, but describe the technical spirit of the present disclosure and a scope the technical spirit of the present disclosure is not limited by the above embodiment and the accompanying drawings. The scope of the right of the present disclosure should be interpreted by the claims and it should be interpreted that the present disclosure should be defined only in accordance with the following claims and their equivalents.

Although a few embodiments have been shown and described, it would be appreciated by those skilled in the art that changes may be made in these embodiments without departing from the principles and spirit of the disclosure, the scope of which is defined in the claims and their equivalents.

What is claimed is:

1. A rotor, comprising;
a cylindrical main core having an inner diameter and an outer diameter which have diameters different from each other;
a plurality of radial cores, each of which extends in a direction perpendicular to an outer circumference edge of the main core;
a plurality of magnetic flux concentration cores placed between the plurality of radial cores, respectively;
a plurality of inner coupling parts, each of which connects the main core and the plurality of magnetic flux concentration cores and has a width smaller than a width of the radial core;
a rotor core having permanent magnet seating parts provided at both sides of the radial core in parallel with the radial core; and
a plurality of permanent magnets placed on the permanent magnet seating parts, and magnetized such that opposite poles face each other with the radial core centered therebetween.

2. The rotor of claim 1, wherein the rotor core further comprises a plurality of inner magnetic flux leakage preventing parts provided at both sides of each of the plurality of inner coupling parts.

3. The rotor of claim 2, wherein the plurality of inner magnetic flux leakage preventing parts comprise a nonmagnetic material.

4. The rotor of claim 1, wherein the rotor core further comprises a plurality of outer coupling parts which connect the plurality of radial cores and the plurality of magnetic flux concentration cores and each of which has a width smaller than the width of the radial core.

5. The rotor of claim 4, wherein the rotor core further comprises a plurality of outer magnetic flux leakage preventing parts placed between the plurality of outer coupling parts and the plurality of permanent magnets, respectively.

6. The rotor of claim 5, wherein the plurality of outer magnetic flux leakage preventing parts comprise a nonmagnetic material.

7. The rotor of claim 1, wherein the plurality of permanent magnets placed at both sides of each of the radial cores are disposed to have an angle of 20 degrees or less.

8. The rotor of claim 1, wherein the width of each of the plurality of inner coupling parts is equal to or less than 1 mm.

9. The rotor of claim 1, wherein the width of each of the plurality of outer coupling parts is equal to or less than 1 mm.

10. The rotor of claim 1, wherein the permanent magnet further comprises a chamfering part formed by chamfering an edge of a circumferential inner portion thereof adjacent to the magnetic flux concentration core, and the rotor core further comprises a magnetization guide part formed such that the magnetic flux concentration core corresponds to the chambering part.

11. The rotor of claim 10, wherein the chamfering part is formed with at least one of a planar face and a curved face.

12. The rotor of claim 10, wherein a width of a circumferential outer portion of the magnetization guide part is the same as a width of a circumferential inner portion thereof.

13. The rotor of claim 10, wherein a width of a circumferential outer portion of the magnetization guide part is smaller than a width of a circumferential inner portion thereof.

14. A motor, comprising;
a shaft;
a stator including a plurality of coils placed at a plurality of teeth, respectively; and
a rotor including a cylindrical main core having an inner diameter and an outer diameter which have diameters different from each other; a plurality of radial cores, each of which extends in a direction perpendicular to an outer circumference edge of the main core; a plurality of magnetic flux concentration cores placed between the plurality of radial cores, respectively; a plurality of inner coupling parts, each of which connects the main core and the plurality of magnetic flux concentration cores and has a width smaller than the width of the radial core; a rotor core having permanent magnet seating parts provided at both sides of the radial core in parallel with the radial core; and a plurality of permanent magnets placed on the permanent magnet seating parts, and magnetized such that opposite poles face each other with the radial core centered therebetween.

15. The motor of claim 14, further comprising a plurality of inner magnetic flux leakage preventing parts provided at both sides of each of the plurality of inner coupling parts.

16. The motor of claim 15, wherein the plurality of inner magnetic flux leakage preventing parts comprise a nonmagnetic material.

17. The motor of claim 14, wherein the plurality of permanent magnets placed at both sides of each of the radial cores are disposed to have an angle of 20 degrees or less.

18. The motor of claim 14, wherein the width of each of the plurality of inner coupling parts is equal to or less than 1 mm.

19. The motor of claim 14, wherein the permanent magnet further comprises a chamfering part formed by chamfering an edge of a circumferential inner portion thereof adjacent to the magnetic flux concentration core, and the rotor core further comprises a magnetization guide part formed such that the magnetic flux concentration core corresponds to the chambering part.

20. The motor of claim 19, wherein a width of a circumferential outer portion of the magnetization guide part is the same as a width of a circumferential inner portion thereof.

21. The motor of claim 19, wherein a width of a circumferential outer portion of the magnetization guide part is smaller than a width of a circumferential inner portion thereof.

22. A motor comprising:
a stator; and
a rotor configured to rotate in the stator, and comprising:
a main core configured to accept a shaft of the motor;
a radial portion connecting the main core to an outer circumferential portion of the rotor and provided in a substantially rectangular shape;
a magnetic flux concentration portion connecting the main core to an outer circumferential portion of the rotor and provided in a substantially wedge shape; and
a permanent magnet provided between the radial portion and the magnetic flux concentration portion,
wherein the magnetic flux concentration portion comprises an inner coupling part, having a width narrower than a width of an interior portion of the radial portion, provided at an interior portion of the magnetic flux concentration portion.

23. The motor of claim 22, further comprising an inner magnetic flux leakage preventing part provided between an interior portion of the permanent magnet and the main core.
